(19) United States
(12) Patent Application Publication
(10) Pub. No.: US 2017/0135525 A1
(43) Pub. Date: May 18, 2017

(54) MILL FOR IMPROVED SEASONING

(71) Applicant: PSP, Quingey (FR)

(72) Inventors: Richard BOUGEROL, Pouilley Les Vignes (FR); Jeremy PIETRZYK, Fraisans (FR)

(73) Assignee: PSP, Quingey (FR)

(21) Appl. No.: 15/316,164

(22) PCT Filed: Jun. 4, 2015
(86) PCT No.: PCT/FR2015/051485

§ 371 Date: Dec. 3, 2016

(30) Foreign Application Priority Data
Jun. 4, 2014 (FR) 1455065

(51) Int. Cl. A47J 42/50; A47J 42/46; A47J 42/04

(52) U.S. Cl. CPC A47J 42/50; A47J 42/04; A47J 42/46

(57) ABSTRACT

The seasoning mill includes a body, a cap closing the top of the body, a cup closing the bottom of the body and a drive shaft positioned inside the body. A first of the drive shaft is secured to a ball able to rotate inside the cup, the drive shaft having a device for agitating the seasoning. An agitating device includes a first blade to push the seasoning downwards in the direction of the cup when the shaft is rotated. The first blade is positioned near the first end of the drive shaft. A bottom end of the first blade has a shape cooperative with an upper edge of the cup, so as to unstick agglomerated seasoning residues from the upper edge of the cup.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The invention relates to a seasoning mill, especially for wet salt, such as for example the Guerande's salt.

2. Description of Related Art Including Information Disclosed Under 37 CFR 1.97 and 37 CFR 1.98

The mill is of the type comprising a body, a cap closing the top of the body, a cup closing the bottom of the body and a driving rod positioned inside the body, a first end of the driving rod being integral with a ball able to rotate inside the cup, the driving rod comprising a device for stirring the seasoning, said stirring device comprising a first blade designed so as to push the seasoning downwards in the direction of said cup when said rod is driven in rotation.

Such a mill is namely described in FR 2 865 368.

The wet salt has the drawback of tending to clog in particular inside the mill, which results into a limited efficiency of the mill. In order to cope therewith, FR 2 865 368 provides a mill the driving rod of which comprises a seasoning stirring device comprising a plurality of notches distributed along the rod.

It is observed in practice that the effectiveness of the notches described in FR 2 865 368 is limited. Though the salt agglomerates are actually broken, at least partially, the amount of salt exiting at every turn of the ball of the mill remains rather small.

Furthermore, the publication BE 530 442, relating to improved grinders and grinding devices, describes a feed hopper extended in its lower portion by a cylindrical channel formed by a helical screw and ending immediately above the grinding organs, but having no stirring device provided with blades. Such a device therefore proves to be unsatisfactory in use because of the above-mentioned clogging problems.

From the publication FR 1 040 281 is also known a pepper mill comprising a “forcing helix” pushing the intact peppercorns by force to the interior of the grinder and which comprises at least two blades. It turns out in use that such a device is well suited for grinding a dry spice such as pepper, but is not at all satisfactory when it is used for grinding a wet salt, such as in particular the Guerande's salt.

### BRIEF SUMMARY OF THE INVENTION

The invention provides a new mill, which is more effective than that of the above-mentioned prior-art documents in that it improves the milling efficiency.

More specifically, the invention provides a mill, which is furthermore consistent with a mill as described in the first paragraph above, characterized in that said first blade is positioned near the first end of said driving rod, and wherein a lower end of said first blade has a shape designed to cooperate with an upper edge of said cup, so as to unstick agglomerated seasoning residues from the upper edge of said cup.

The first blade breaks the seasoning agglomerates present in the lower portion of the body of the mill. In addition, by pushing the seasoning downwards in the direction of the cup, the first blade facilitates its grinding; the efficiency of the mill is thus largely improved.

To this end, according to one embodiment, one end of a radial lower edge of the first blade has a setback with a shape complementary to the shape of the upper edge of the cup.

In addition, the stirring device can comprise a plurality of blades distributed along the driving rod; during the rotation of the rod, the plurality of blades break the spice agglomerates inside the body and over the entire height of the body of the mill.

The ball has on its outer wall a plurality of grooves cooperating with grooves present on an inner wall of the cup for grinding the seasoning. The grooves on the wall of the ball are inclined according to an average angle alpha of 30° to 60° relative to the longitudinal axis of the rod, and the grooves on the wall of the cup are inclined according to a very different angle, for example an angle from 0° (corresponding to grooves in planes parallel to the longitudinal axis) to −60°; thus, during the rotation of the ball in the cup, the seasoning corns are crushed between the ball and the cup due to the orientation of the grooves of the ball that is very different from the orientation of the grooves of the cup. The direction of inclination of the grooves of the ball defines the direction in which the driving axis should be rotated so that the grinding mechanism is effective.

In a practical embodiment of the invention, the first blade or each blade of the plurality of blades forms an angle beta the value of which is included in the same angular quadrant as the angle of inclination alpha of the grooves of the ball, for example an angle beta of 30 to 60° relative to a longitudinal axis of the rod. With this inclination, quite close to that of the grooves of the ball, the blade or blades push the seasoning downwards when the rod of the mill is driven in rotation in the “right” direction for grinding.

The blades 41, 45 can be flat; they can also be curved, preferably with a concavity facing downwards; the thrust force exerted by the blades on the seasoning is thereby improved.

Preferably, a distance between the driving rod and a longitudinal edge of a blade is smaller than a distance between the driving rod and an inner wall of the body of the mill. Thus, the blade or blades do not rub against the inner wall of the body of the mill, thus avoiding scratching said wall.

According to one embodiment, the stirring device may comprise a tube comprising a first blade or a plurality of blades arranged on an outer wall of the tube, and a means for immobilizing the stirring device in rotation with respect to the rod when the tube is mounted on the rod. The stirring device and the driving rod are thus two separate parts, which are associated during the assembling of the mill. The assembling of the mill is thus facilitated.

According to another peculiarity of a mill according to the invention, a bottom face of the ball is extended by a plurality of fins: each fin extends along a radial axis and each fin is arranged so as to cooperate with a bottom face of the cup. The fin or fins form a spacer between the ball and the cup and thus avoid any friction between the ball and the cup; in addition, a centering stop provides additional guidance and support. These peculiarities eliminate the risk of eroding the teeth formed by the grooves on the wall of the cup or the wall of the ball, which teeth are particularly thin and therefore fragile; this is important namely in the case of a ball+cup mechanism made of ceramic, which material is brittle and dangerous if swallowed.

At least one fin may have at least one radial side arranged so as to cooperate with the bottom face of the cup, in order to unstick agglomerated seasoning residues from the upper edge of the cup.

### BRIEF DESCRIPTION OF THE SEVERAL VIEWS OF THE DRAWINGS

The invention will be better understood and further features and advantages of the invention will become clear from the following description of an example of a mill according to the invention. These examples are given in a non-restrictive way. The description should be read together with the attached drawings.

FIG. 1 is an exploded perspective view of a mill according to the invention.

FIGS. 2 to 5 are partial schematic views of the assembled mill, with the body cut away in order to show the components positioned inside.

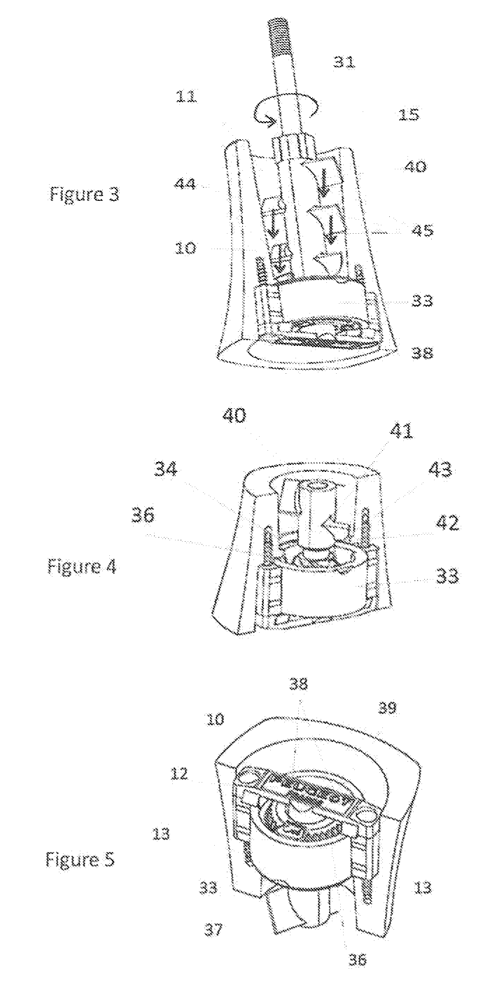

### DETAILED DESCRIPTION OF THE INVENTION

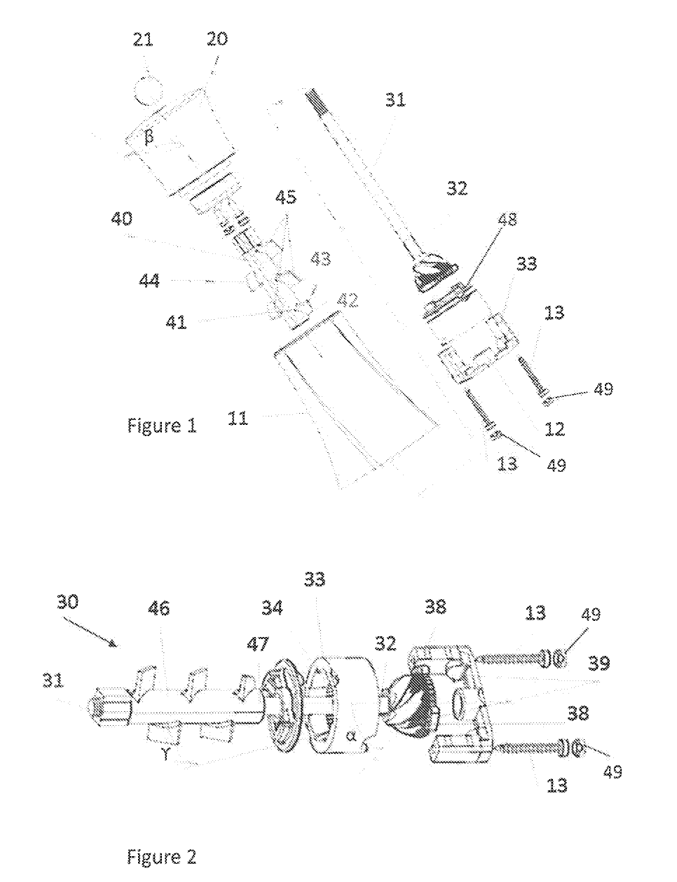

The reference position of the mill is the vertical position, with the cap above the seasoning container and the grinding mechanism (ball +cup) below said container. The notions of “top”, “bottom”, “above”, “below” are defined with respect to this reference position. The longitudinal axis of the mill is the axis of rotation of the driving rod of the ball, i.e. a vertical axis in the reference position of the mill. For the definition of the angles, the positive direction of the longitudinal axis is oriented from the ball towards the cap of the mill (FIG. 1).

As said above, the invention relates to a seasoning mill, in particular for wet salt. The mill comprises a body 10, a cap 20, a cup 33 and a rod 31.

The cap 20 closes the top of the body. The cup 33 closes the bottom of the body, is maintained integral with the body by means of a flange 12 and screws 13, for example made of stainless steel, and which can each advantageously be covered with a plug 49 made of plastic material and protecting them against all risks of corrosion. The driving rod 31 is positioned inside the body; a first end of the driving rod is integral with a ball 36 movable in rotation inside the cup; a second end of the rod is integral with the cap. An upper portion of the body 10 is hollow, so as to form a seasoning container 11.

The ball 36 has on its outer wall a plurality of grooves 37 cooperating with grooves 34 present on an inner wall of the cup 33 in order to grind the seasoning. In the example being shown, the grooves 37 on the wall of the ball are inclined according to an average angle alpha (α) of +20 to +40° relative to the longitudinal axis of the rod (these are in practice grooves located on a helix of a pitch between 40 and 60 mm), and the grooves 34 on the wall of the cup are inclined according to an angle that can be quite different, for example according to an average angle gamma (γ) of +15 to +35°.

The grooves 34, 37 can be straight; in this case, the angle of inclination alpha is the angle between the longitudinal axis of the driving rod and a straight line tangential to the grooves. In the example being shown, the grooves have the shape of a circular arc; in this case, the average angle of inclination alpha, gamma of a groove is the mean value of the angles between the longitudinal axis of the driving rod and the straight lines tangential to said groove at any point of the curve of said groove.

The direction of the inclination of the grooves of the ball is important because it defines the direction in which the driving axis should be driven in rotation so that the grinding mechanism is effective (arrow 15).

In the example being shown, the stirring device comprises a plurality of blades 45 distributed along the driving rod 31. The first blade 41 is positioned near the first end of the driving rod, and a lower radial edge 42 of the first blade has a setback 43. The blades are slightly curved, with a concavity facing downwards, and are inclined according to an average angle beta (β) of about 45°. Also, the distance between the driving rod 31 and a longitudinal edge 44 of a blade 41, 45 is 0.2 to 2 mm smaller than a distance between the driving rod and an inner wall of the body of the mill.

From a practical perspective of carrying out, the stirring device comprises a tube 46 on the outer wall of which are distributed the plurality of blades 41, 45. One end of the tube has a square inner cross-section 47 and cooperates with a square outer cross-section 32 of the driving rod near the ball. This forms a means for immobilizing the stirring device in rotation with respect to the rod when the tube is mounted on the rod.

In the mill being shown, the ball 36 has a generally truncated cone shape; a bottom face of the ball is extended by three blades 38 distributed along the perimeter of the bottom face of the ball; the fins 38 form a spacer between the ball 36 and the cup 33; each fin extends along a radial axis; each fin is into contact with a bottom face of the cup when the mill is mounted. The fins have at least one radial side 39, thus forming a blade for cleaning the bottom face of the cup. Furthermore, a centering stop 48 provides additional guidance and support.

The mill prototypes and the mills according to the invention are and will be completely made of materials not or little subject to corrosion, namely, but non-restrictively:
plastic, wood, etc., for the body and the mill cap
ceramics for the ball and the cup,
plastic for the rod, plastic molded on the ball
plastic for the flange and the screw plugs, stainless steel for the bolts for fastening the flange
plastic, wood, stainless steel, etc. for the button

### NOMENCLATURE

10 body

11 container

12 flange

13 screw

15 direction of rotation for grinding

20 cap

21 button

30 grinding mechanism

31 driving rod

32 square cross-section at the bottom of the rod

33 cup

34 grooves

γ, gamma, orientation of the grooves 34

36 ball

37 grooves

α, alpha, orientation of the grooves 37

38 fins

39 radial side of the fins

40 stirring device

41 first blade

42 lower radial edge

43 setback

44 longitudinal edge

45 plurality of blades

β, beta, orientation of the blades

46 tube

47 square cross-section of the tube

48 centering stop

49 plugs

1. A mill for seasoning, in particular for wet salt, the mill comprising:
a body;
a cap closing a top of the body;
a cup closing a bottom of said body; and
a driving rod positioned within said body, a first end of said driving rod being integral with a ball being movable in rotation inside said cup,
wherein said driving rod comprises: a seasoning stirring device, said stirring device comprising: a first blade arranged so as to push the seasoning downwards towards said cup when said rod is driven in rotation,
wherein said first blade is positioned near the first end of said driving rod, and
wherein a bottom end of said first blade is cooperative with an upper edge of said cup, so as to unstick agglomerated seasoning residues from the upper edge of said cup.

2. The mill, according to claim 1, wherein an end of a lower radial edge of the first blade has a setback.

3. The mill, according to claim 1, wherein the stirring device comprises a plurality of blades distributed along the driving rod.

4. The mill, according to claim 1, wherein the first blade of the plurality of blades forms an angle of 30 to 60° relative to a longitudinal axis of the rod.

5. The mill, according to claim 1, wherein the ball has a plurality of grooves on an outer wall inclined according to an average angle of 30 to 60° relative to the longitudinal axis of the rod.

6. The mill, according to claim 1, wherein a distance between the driving rod and a longitudinal edge of a blade is smaller than a distance between the driving rod and an inner wall of the body of the mill.

7. The mill, according to claim 1, wherein the stirring device comprises: a tube comprising a first blade arranged on an outer wall of the tube, and a means for immobilizing the stirring device in rotation relative to the rod when the tube is mounted on the rod.

8. The mill, according to claim 1, wherein the ball has a general truncated cone shape, and wherein a bottom face of the ball is extended by a plurality of fins forming a spacer between the ball and the cup, each fin extending along a radial axis, each blade being arranged so as to cooperate with a bottom face of the cup.

9. The mill, according to claim 8, wherein at least one fin has at least one radial side arranged so as to cooperate with the bottom face of the cup in order to unstick agglomerated seasoning residues from the upper edge of the cup.

10. The mill, according to claim 1, being comprised of materials resistant to corrosion.
